(19) United States
(12) Patent Application Publication
(10) Pub. No.: US 2009/0144507 A1
(43) Pub. Date: Jun. 4, 2009

(54) APPARATUS AND METHOD FOR IMPLEMENTING REFRESHLESS SINGLE TRANSISTOR CELL eDRAM FOR HIGH PERFORMANCE MEMORY APPLICATIONS

(75) Inventors: John E. Barth, JR., Williston, VT (US); Erik L. Hedberg, Essex Junction, VT (US); Robert M. Houle, Williston, VT (US); Hillery C. Hunter, Somers, NY (US); Peter A. Sandon, Essex Junction, VT (US)

Correspondence Address: CANTOR COLBURN LLP-IBM BURLINGTON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/950,015

(22) Filed: Dec. 4, 2007

(51) Int. Cl. G06F 12/08

(52) U.S. Cl. 711/144; 711/E12.017

(57) ABSTRACT

An apparatus for implementing a refreshless, embedded dynamic random access memory (eDRAM) cache device includes a cache structure having a cache tag array associated with a DRAM data cache with a plurality of cache lines, the cache tag array having an address tag, a valid bit and an access bit corresponding to each of the plurality of cache lines; and each access bit configured to indicate whether the corresponding cache line has been accessed as a result of a read or a write operation during a defined assessment period, the defined assessment period being smaller than retention time of data in the DRAM data cache. For any of the cache lines that have not been accessed during the defined assessment period, the individual valid bit associated therewith is set to a logic state that indicates the data in the associated cache line is invalid.

### BACKGROUND

The present invention relates generally to integrated circuit memory devices and, more particularly, to an apparatus and method for implementing refreshless single FET device cell embedded dynamic random access memory (eDRAM) for high performance memory applications.

Memory devices are used in a wide variety of applications, including computer systems. Computer systems and other electronic devices containing a microprocessor or similar device typically include system memory, which is generally implemented using dynamic random access memory (DRAM). An eDRAM memory cell typically includes, as basic components, an access transistor (switch) and a capacitor for storing a binary data bit in the form of a charge. Typically, a first voltage is stored on the capacitor to represent a logic HIGH or binary “1” value (e.g., V_{DD}), while a second voltage on the storage capacitor represents a logic LOW or binary “0” value (e.g., ground).

The primary advantage of DRAM is that it uses relatively fewer components to store each bit of data as opposed to, for example, SRAM memory which requires as many as 6 transistor devices. Consequently, DRAM memory is more area efficient and a relatively inexpensive means for providing embedded memory. A disadvantage of eDRAM, however, is DRAM memory cells must be periodically refreshed as the charge on the capacitor eventually leaks away and therefore provisions must be made to “refresh” the capacitor charge. Otherwise, the data stored by the memory is lost. Moreover, portions of DRAM memory that are being refreshed cannot be accessed for reads or writes. Consequently, refreshing DRAM memory in a high performance system can adversely impact memory availability to the processing unit, and diminish overall system performance. The need to refresh DRAM memory cells does not present a significant problem in most applications, but it can prevent the use of DRAM in applications where immediate access to memory cells is required or highly desirable.

More recently, embedded DRAM (eDRAM) macros have been considered, particularly in the area of Application Specific Integrated Circuit (ASIC) technologies. For example, markets in portable and multimedia applications such as cellular phones and personal digital assistants utilize the increased density of embedded memory for higher function, higher system performance, and lower power consumption.

Also included in many computer systems and other electronic devices is a cache memory. Cache memory stores instructions and/or data (collectively referred to as “data”) that are frequently accessed by the processor or similar device, and may be accessed substantially faster than instructions and data can be accessed from off-chip system memory. If the cache memory cannot be accessed as needed (e.g., due to periodic eDRAM refreshing), the operation of the processor or similar device must be delayed until after refresh.

Cache memory is typically implemented using static random access memory (SRAM) because such memory need not be refreshed and is thus always accessible for a write or a read memory access. However, a significant disadvantage of SRAM is that each memory cell requires a relatively large number of transistors, thus making SRAM data storage relatively expensive. It would be desirable to implement cache memory using eDRAM because high capacity cache memories could then be provided at lower cost and chip area savings. However, a cache memory implemented using eDRAMs would be inaccessible at certain times during a refresh of the memory cells in the eDRAM. As a result of these problems, eDRAMs have not generally been considered acceptable for use as cache memory or for other applications requiring immediate access by processing units.

### SUMMARY

The foregoing discussed drawbacks and deficiencies of the prior art are overcome or alleviated by an apparatus for implementing a refreshless, embedded dynamic random access memory (eDRAM) cache device, including a cache structure having a cache tag array associated with a eDRAM data cache comprising a plurality of cache lines, the cache tag array having an address tag, a valid bit and an access bit corresponding to each of the plurality of cache lines; and each access bit configured to indicate whether the corresponding cache line associated therewith has been accessed as a result of a read or a write operation during a defined assessment period, the defined assessment period being smaller than retention time of data in the DRAM data cache; wherein, for any of the cache lines that have not been accessed as a result of a read or a write operation during the defined assessment period, the individual valid bit associated therewith is set to a logic state that indicates the data in the associated cache line is invalid.

In another embodiment, a method of implementing a refreshless, embedded dynamic random access memory (eDRAM) cache device includes configuring a cache structure including a cache tag array associated with a DRAM data cache comprising a plurality of cache lines, the cache tag array having an address tag, a valid bit and an access bit corresponding to each of the plurality of cache lines; configuring each access bit to indicate whether the corresponding cache line associated therewith has been accessed as a result of a read or a write operation during a defined assessment period, the defined assessment period being smaller than retention time of data in the DRAM data cache; and for any of the cache lines that have not been accessed as a result of a read or a write operation during the defined assessment period, setting the individual valid bit associated therewith to a logic state that indicates the data in the associated cache line is invalid.

### BRIEF DESCRIPTION OF THE DRAWINGS

Referring to the exemplary drawings wherein like elements are numbered alike in the several Figures:

FIG. 1 is a schematic diagram of an exemplary processor cache memory structure suitable for use in accordance with an embodiment of the invention;

FIG. 2 is a schematic diagram of a portion of the SRAM based tag array of FIG. 1, which facilitates a method of implementing refreshless eDRAM through invalidating expired data using an access bit;

FIG. 3(a) is a timing diagram illustrating the operation of the access bit, in accordance with a further embodiment of the invention; and

FIG. 3(b) is a truth table illustrating the relationship between the access bit and the valid bit.

### DETAILED DESCRIPTION

Disclosed herein is a method and apparatus for implementing a refreshless single device embedded dynamic random access memory (eDRAM) for high performance memory applications. Most processors' level one (L1) cache memories utilize a “valid” bit (i.e., a first status bit) and a “modify” bit (i.e., a second status bit) in an L1 tag SRAM array. Herein, a new “access” bit (i.e., a third status bit) is defined and implemented in the tag array, and which indicates the status of cache lines or words in terms of dynamic eDRAM data integrity. In particular, by integrating an access bit along side the valid bit line, a new protocol may be implemented, thereby permitting the enablement of refreshless eDRAM for L1 cache memory, as described in further detail hereinafter.

As will be appreciated, there are both advantages and disadvantages associated with migrating eDRAM into L1 and L2 processor memory levels. Notwithstanding a 3 to 1 area advantage over SRAM memory, one major disadvantage of eDRAM is refresh, as indicated above. With high performance eDRAM, refresh operations can adversely impact memory availability, performance and power. By eliminating refresh on highly utilized eDRAM memory, valuable array data that is consistently updated can be preserved, while “less active” data that is not “essential” data can be left to expire. The usefulness and feasibility of eliminating refresh of the L1 level eDRAM may be realized upon consideration of the following calculation:

Typically, up to 40% of processor instructions are load or store instructions that access memory. Of these, around 93% might hit in the L1 cache. In a 5 GHz processor executing one instruction per cycle on average, this corresponds to an access of the L2 cache once every 0.54 nanoseconds. Typical retention time for an eDRAM in current technology is around 40 microseconds. Thus, the L1 cache will be accessed about 80,000 times during the retention period. Assuming the cache is organized such that every access restores the charge on a full cache line, then for a 16 KB L1 cache containing 512 32B cache lines, each cache line is accessed around 160 times during each retention period. At this rate, the probability that all the cache lines currently in use will be accessed during a retention period is very high.

Accordingly, based on the above calculation, L1 caches having refreshless eDRAM is a viable concept. Moreover, the present disclosure applies to any level of cache in the processor memory hierarchy (e.g., L1, L2, L3, etc.) in which the ratio of retention period to recycle period is favorable. Processor utilization requirements of an L1 eDRAM array may result in the ability to eliminate the need to refresh such array. Consequently, data that is accessed frequently remains refreshed and valid, while data described as “old” or “not accessed” will become volatile and expire.

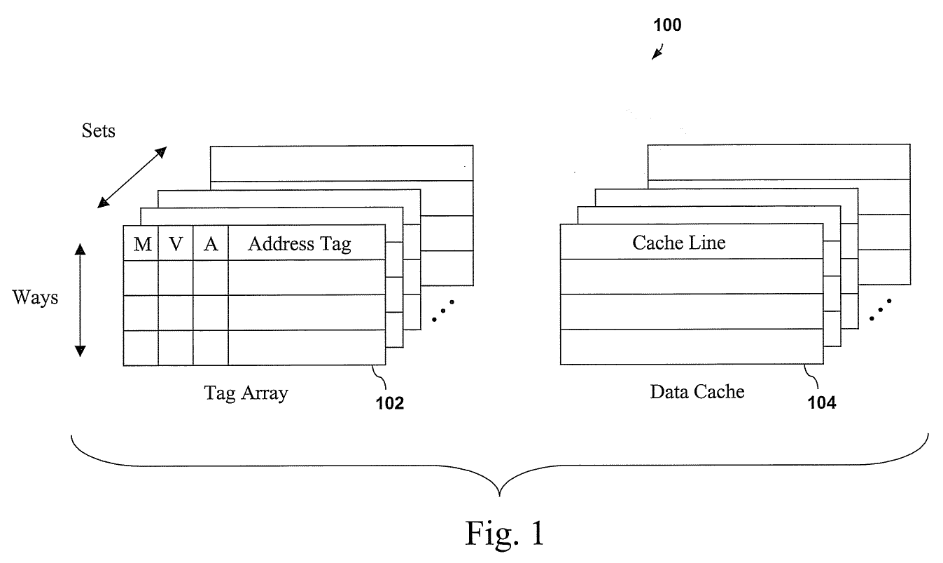

Referring now to FIG. 1, there is shown a schematic diagram of an exemplary processor cache memory structure 100 (e.g., an on-chip L1 cache integrated with a central procession unit or “CPU”) suitable for use in accordance with an embodiment of the invention. The cache structure 100 includes an SRAM based tag array 102 and a DRAM based data cache 104. The tag array 102 is a content addressable SRAM (CAM) and stores address tags that map the data array. During a processor request for data, the tag array 102 searched to establish whether or not the requested data needed is held in the data cache 104. In the event of a tag “hit,” the data cache 104 is activated (accessed) and provides the processor with valid data.

Due to processing consequences, the tag array includes a number of “flags” or status bits that are used to describe cache data integrity or state. More specifically, each address tag is marked with a number of defined status bits. In the illustrated embodiment of FIG. 1, three separate status bits are abbreviated M (modified), V (valid), and A (access), wherein M indicates whether the data has been modified, V defines the data as valid, and A defines eDRAM data that has been accessed within the current assessment period, as described below. In particular, the modify bit designates a situation where the data held in the cache has been modified. Any lines that have been modified will be cast out through the memory hierarchy (i.e., copied to the next level in the hierarchy so that the data is not lost). This may be done, for example, by a sweep mechanism that checks the tags for modified bits, forcing a cast out whenever a modified bit is set. However, if the cache is in a write-through configuration, this step is not necessary. The valid bit indicates that the corresponding data in the cache is a copy of the current data held in the main memory. Thirdly, the access bit is implemented in such a way as to ensure data integrity in a refreshless eDRAM cache array, as described below.

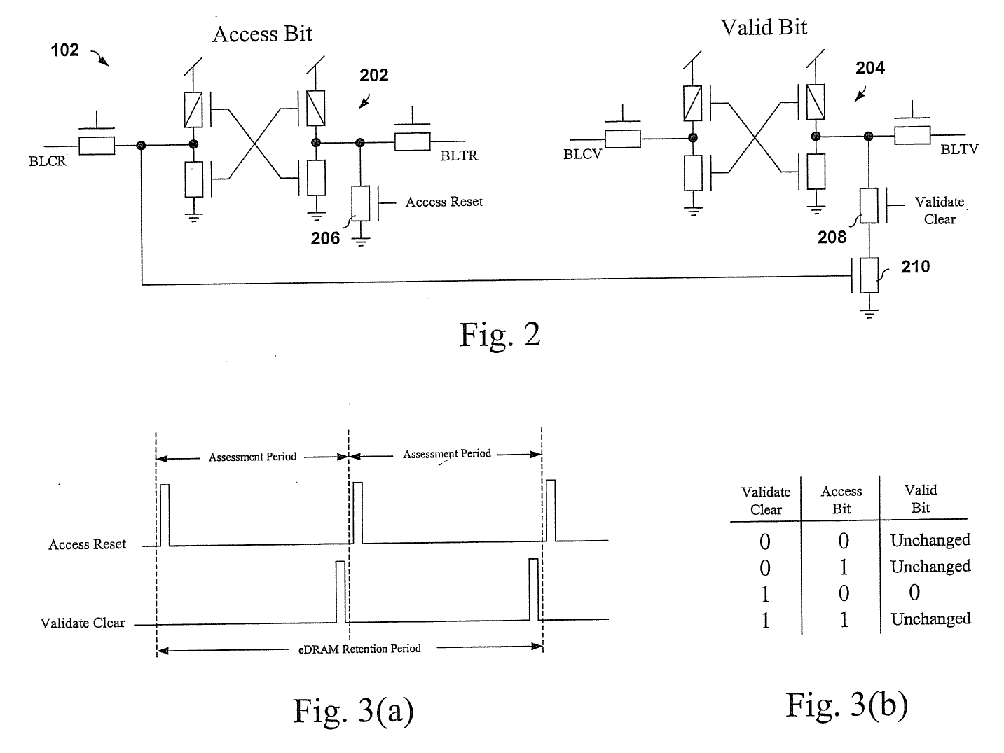

Referring to FIG. 2, there is shown a schematic diagram of a portion of the SRAM based tag array 102 of FIG. 1, which facilitates a method of invalidating expired data through an “access bit” identified above. Whereas an existing processor L1 cache memory may integrate a valid bit and a modify bit as status bits in an L1 tag array, the present embodiments further incorporate the new access bit as a third status bit within the tag array 102, which indicates the status of cache lines or words in terms of dynamic eDRAM data integrity. As shown in FIG. 2, both the access bit 202 and the valid bit 204 of the L1 cache tag array 102 include a 6-transistor SRAM cell, in addition to discharge NFETs 206, 208, respectively coupled to the true data nodes of the cells, for setting the state of the bits. As also shown in FIG. 2, NFET 208 is also connected in series with another NFET 210, which is controlled by the complementary data node of the access bit 202.

Data in the L1 cache automatically refreshes during eDRAM read and write operations. Subsequently, any reads or writes of a cache line or word will update its corresponding tag access bit to a “1”, thus confirming valid data. Implementation of the access bit structure may be configured with varying degrees of data resolution, from cache lines to sectors. The operability of the refreshless eDRAM cache may be implemented by establishing a “safe” retention interval metric that ensures data integrity. Once that metric has been established, a valid assessment (evaluation) interval can be executed. Each time this metric interval has been achieved, data evaluation in terms of data expiration is determined.

Referring now to the timing diagram FIG. 3(a) in addition to FIG. 2, the operation of the access bit will be understood. For a given eDRAM cell retention time period, there is defined at least two assessment periods for the cell time retention period. Stated another way, the assessment interval may be defined to be ½ the maximum eDRAM retention interval. Thus, for an eDRAM cell retention time period of (for example) 40 μs, there are two-20 μs assessment periods defined therein.

At the beginning of each assessment period, the access bit 202 is reset through a pulse on the gate of NFET 206, thus placing a logic low value on the true (right) node of the cell and a logic high value on the complement (left) node of the cell. Thus, the gate of NFET 210, coupled to the valid bit 204, is initially high after the start of the assessment period. If the cache line is not thereafter accessed by the end of the assessment period, the access bit will not be “set” (meaning that the value of the true node would switches to high and the gate of NFET 210 would be switched off). Consequently, when the “validate clear” signal pulses at the end of the assessment period, both NFETs 208 and 210 will be simultaneously conductive, thereby discharging the true node of the valid bit 204 and ensuring that the valid bit is set to 0. This then indicates that the cache line was not accessed and therefore the data will be marked as invalid, since the line was not refreshed by an access (e.g., read, write) operation.

On the other hand, if the access bit is set (by an access operation) following the initial reset thereof, and before pulsing of the validate clear signal in an assessment period, then NFET 210 will be deactivated when NFET208 is pulsed active by the “validate clear” signal. In this case, the status of the valid bit will remain unchanged as also reflected in the truth table of FIG. 3(b). Accordingly, for cache data to remain valid within a given assessment period, a tag hit must occur causing the access bit to be set to a “1”. Finally, the onset of a new assessment interval is marked by another pulse of the “access reset” signal on the gate of NFET 206, which resets the access bit 202 to a “0”. Again, any tag hit that occurs during the new assessment interval will set the access bit back to a “1”, designating a data refresh performed as a consequence to an eDRAM cache read or write operation.

The invention embodiments are most easily applied to a cache that is managed in “write-through” mode, such that modified data is always copied to a higher level in the memory hierarchy whenever it is written to this cache. In that case, no data is lost when a cache line is invalidated by the mechanism described herein. In the case of a cache that is managed in “write-back” mode, such that the only copy of a modified line of data is maintained in the cache, the invention embodiments may also be applied. In this latter case, modified data that is not accessed during an assessment period must be copied back up the memory hierarchy during the following assessment period. The mechanism required to “clean” the cache in this way would sweep through all entries in the tag array, forcing the copy-back of data for all lines whose modified bit is asserted, but whose access bit is negated.

Thus configured, the novel cache tag array facilitates a refreshless eDRAM through the use of an access bit that tracks access of a cache line during a defined evaluation period with respect to the eDRAM cell retention time. Those bits associated with accessed lines (and thus automatically refreshed) during the evaluation period are allowed to remain valid, while those that are not are then designated as not valid. In addition to the exemplary application discussed above, further guard banding can be accomplished with the use of data parity circuits in the data cache. For example, single cell retention fails can be handled (in unmodified data) by forcing an invalidation of the line whenever a parity error is detected.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for implementing a refreshless, embedded dynamic random access memory (eDRAM) cache device, comprising:
a cache structure including a cache tag array associated with a DRAM data cache comprising a plurality of cache lines, the cache tag array having an address tag, a valid bit and an access bit corresponding to each of the plurality of cache lines; and
each access bit configured to indicate whether the corresponding cache line associated therewith has been accessed as a result of a read or a write operation during a defined assessment period, the defined assessment period being smaller than retention time of data in the DRAM data cache;
wherein, for any of the cache lines that have not been accessed as a result of a read or a write operation during the defined assessment period, the individual valid bit associated therewith is set to a logic state that indicates the data in the associated cache line is invalid.

2. The apparatus of claim 1, wherein each access bit is reset to a first logic state at the beginning of each assessment period.

3. The apparatus of claim 2, wherein a read or write operation of a given cache line causes the associated access bit to be set to a second logic state opposite the first logic state.

4. The apparatus of claim 3, further comprising a validate clear signal applied to each valid bit at the end of each assessment period, wherein the validate clear signal causes the valid bit to be set to the invalid logic state in the event that the access bit has not been switched from the first logic state to the second logic state as a result of a read or write operation during the assessment period.

5. The apparatus of claim 4, wherein both the valid bits and access bits of the cache tag array comprise static random access memory (SRAM) cells.

6. The apparatus of claim 5, further comprising a first NFET device configured to discharge a first data node of the access bit SRAM cell, the first NFET device activated by a first control signal pulsed at the beginning of each assessment period.

7. The apparatus of claim 6, further comprising:
a second NFET device coupled to a first data node of the valid bit; and
a third NFET device in series with the second NFET device, the second NFET device activated by a second control signal comprising the validate clear signal, and the third NFET device coupled to a second data node of the access bit SRAM cell;
wherein the second and third NFET devices are configured to set valid bit to the invalid logic state upon simultaneous activation thereof.

8. The apparatus of claim 1, wherein the assessment period is about ½ the retention time of data in the DRAM data cache.

9. The apparatus of claim 1, wherein the cache structure comprises an L1 cache.

10. The apparatus of claim 1, wherein the cache tag array further comprises a modify bit corresponding to each of the plurality of cache lines, the modify bit configured to indicate whether the data in the corresponding cache line has been modified, wherein any lines that have been modified are cast out through a memory hierarchy.

11. A method of implementing a refreshless, embedded dynamic random access memory (eDRAM) cache device, the method comprising:
configuring a cache structure including a cache tag array associated with a DRAM data cache comprising a plurality of cache lines, the cache tag array having an address tag, a valid bit and an access bit corresponding to each of the plurality of cache lines;
configuring each access bit to indicate whether the corresponding cache line associated therewith has been accessed as a result of a read or a write operation during a defined assessment period, the defined assessment period being smaller than retention time of data in the DRAM data cache; and
for any of the cache lines that have not been accessed as a result of a read or a write operation during the defined assessment period, setting the individual valid bit associated therewith to a logic state that indicates the data in the associated cache line is invalid.

12. The method of claim 11, further comprising resetting each access bit to a first logic state at the beginning of each assessment period.

13. The method of claim 12, further comprising setting an associated bit for a given cache line to a second logic state opposite the first logic state upon a read or write operation of the given cache line.

14. The method of claim 13, further comprising applying a validate clear signal to each valid bit at the end of each assessment period, wherein the validate clear signal causes the valid bit to be set to the invalid logic state in the event that the access bit has not been switched from the first logic state to the second logic state as a result of a read or write operation during the assessment period.

15. The method of claim 14, wherein both the valid bits and access bits of the cache tag array comprise static random access memory (SRAM) cells.

16. The method of claim 15, further comprising configuring a first NFET device configured to discharge a first data node of the access bit SRAM cell, the first NFET device activated by a first control signal pulsed at the beginning of each assessment period.

17. The method of claim 16, further comprising:
coupling a second NFET device to a first data node of the valid bit; and
configuring a third NFET device in series with the second NFET device, the second NFET device activated by a second control signal comprising the validate clear signal, and the third NFET device coupled to a second data node of the access bit SRAM cell;
wherein the second and third NFET devices are configured to set valid bit to the invalid logic state upon simultaneous activation thereof.

18. The method of claim 11, wherein the assessment period is about ½ the retention time of data in the DRAM data cache.

19. The method of claim 11, wherein the cache structure comprises an L1 cache.

20. The method of claim 11, further comprising configuring the cache tag array with a modify bit corresponding to each of the plurality of cache lines, the modify bit configured to indicate whether the data in the corresponding cache line has been modified, wherein any lines that have been modified are cast out through a memory hierarchy.
